(19) United States
(12) Patent Application Publication
(10) Pub. No.: US 2025/0026965 A1
(43) Pub. Date: Jan. 23, 2025

(54) LIGHT RADIATION-DEBONDABLE PRESSURE SENSITIVE ADHESIVES

(71) Applicant: 3M INNOVATIVE PROPERTIES COMPANY, St. Paul, MN (US)

(72) Inventors: Encai Hao, Woodbury, MN (US); Yongshang Lu, Woodbury, MN (US); Jason D. Clapper, Lino Lakes, MN (US)

(21) Appl. No.: 18/716,584

(22) PCT Filed: Nov. 30, 2022
(86) PCT No.: PCT/IB2022/061591

§ 371 Date: Jun. 5, 2024

Related U.S. Application Data
(60) Provisional application No. 63/265,197, filed on Dec. 10, 2021.

(51) Int. Cl. C09J 7/38; B32B 7/12; B32B 17/06

(52) U.S. Cl. CPC C09J 7/38; B32B 7/12; B32B 17/06; B32B 2255/26; B32B 2307/748; C09J 2301/302; C09J 2301/416

(57) ABSTRACT

The present invention is a pressure sensitive adhesive including a polyurethane polymer comprising a reaction product of an isocyanate, a (meth) acrylate-containing alcohol having at least one (meth)acrylate group and at least one alcohol group, and a polyol component having a defined solubility parameter of less than about 10; an oligomer comprising a multifunctional (meth)acrylate; and a photoinitiator. A peel adhesion of the pressure sensitive adhesive to glass decreases at least about 20% after being exposed to light radiation.

### FIELD OF THE INVENTION

The present invention is related generally to the field of pressure sensitive adhesives. In particular, the present invention is a pressure sensitive adhesive that is debondable after exposure to light radiation.

### BACKGROUND

In use, adhesive tapes, such as pressure-sensitive adhesive tapes, are generally bonded firmly to substrates with subsequent separation of the adhesive tape from the substrate being neither intended nor desired. However, certain adhesive tapes are specifically formulated to allow for clean and easy separation from substrates after use. These specifically formulated adhesives usually do not exhibit a substantial level of holding power. e.g., greater than about 4 to 6 oz./in, adhesion to standard copy paper. By contrast, adhesives formulated to provide a substantial level of adhesion, e.g., greater than 30 oz./in, adhesion to paper, are generally difficult to remove without damaging the substrate.

Stretch releasing adhesive tapes represent a class of high-performance pressure-sensitive adhesives that combine strong holding power with clean removal and no surface damage. Such stretch releasing adhesive tapes are useful in a wide variety of assembling, joining, attaching, and mounting applications. Adhesive tape strips that can be cleanly removed from a surface by stretching the tape strip are known in the an Commercial stretch releasing adhesive tapes are currently manufactured as discrete strips with one end of the strip including a non-adhesive pull tab to facilitate stretching of the strip during removal. The adhesive surfaces of the strip are additionally protected with a release liner. Typically, stretch releasing adhesive tapes apply relatively high stress during the removal process, and releasing adhesive tapes typically require a tab in order to initiate the stretch.

Within the last of couple of years, OLED displays have been rapidly developing toward being used in flexible, foldable devices. This requires that the OLED stacks are fabricated on flexible devices that can be folded. Currently, OLED fabrication is typically done on a carrier glass. After the device is manufactured, the OLED stack then needs to be released from the carrier glass. In an alternate process, the OLED stack can also be built on a flexible, thin piece of glass and the OLED device can utilize the flexible glass as the cover glass. In this case, the flexible, thin piece of glass needs to be bonded on a carrier film. Again, the glass carrier film needs to be released after fabrication of the OLED stack. For these applications, optically clear adhesives (OCAs) can be extremely useful. The OCA is used to bond film substrates such as PET, PI, and COP films together with glass during the OLED manufacturing process, with very low adhesion favoring the glass side before removing the carrier film substrates. The adhesion is very important as any extra stresses can damage the OLED stack during the removal process.

### SUMMARY

In one embodiment, the present invention is a pressure sensitive adhesive including a polyurethane polymer including a reaction product of an isocyanate, a (meth)acrylate-containing alcohol having at least one (meth)acrylate group and at least one alcohol group, and a polyol component having a defined solubility parameter of less than about 10; an oligomer including a multifunctional (meth)acrylate; and a photoinitiator. A peel adhesion of the pressure sensitive adhesive to glass decreases by at least about 20% after being exposed to light radiation.

In another embodiment, the present invention is a composition including a polyurethane polymer including a reaction product of an isocyanate, a (meth)acrylate-containing alcohol having at least one (meth)acrylate group and at least one alcohol group, and a polyol component having a defined solubility parameter of less than about 10; a reactive oligomer including a multifunctional (meth)acrylate; and a photoinitiator. When the composition is laminated to glass and UV radiated, the composition has a peel adhesion to the glass of about 2 Newtons per centimeter or less.

In yet another embodiment, the present invention is a laminate including a substrate having at least one major surface, glass having at least one major surface, and a pressure sensitive adhesive. The pressure sensitive adhesive includes a polyurethane polymer which is a reaction product of an isocyanate, a (meth) acrylate-containing alcohol having at least one (meth)acrylate group and at least one alcohol group, and a polyol component having a defined solubility parameter of less than about 10; a reactive oligomer including a multifunctional (meth) acrylate; and a photoinitiator. After exposure to light radiation, the pressure sensitive adhesive has a peel adhesion to the glass of about 2 Newtons per centimeter or less.

### DETAILED DESCRIPTION

The present invention is a light radiation debondable pressure sensitive adhesive. In one embodiment, the pressure sensitive adhesive is a polyurethane adhesive composition having strong initial bonding to both film substrates and glass. Upon light radiation, the pressure sensitive adhesive remains strongly bonded to the film substrate while adhesion to the glass will be significantly reduced, allowing clean removal of the film substrates from the glass. In one embodiment, the pressure sensitive adhesive is optically clear.

The light radiation debondable pressure sensitive adhesive of the present invention generally includes a polyurethane polymer, an oligomer comprising a multifunctional (meth)acrylate, and a photoinitiator. The polyurethane polymer generally includes a reaction product of an isocyanate, a (meth)acrylate-containing alcohol having at least one (meth)acrylate group and at least one alcohol group, and a polyol component having a defined solubility parameter of less than about 10. If the solubility parameter of the polyol component is higher than 10, it may be too polar and will not debond after UV curing. In one embodiment, the light radiation debondable pressure sensitive adhesive includes between about 70 and about 98 wt % polyurethane polymer, particularly between about 75 and about 95 wt % polyurethane polymer, and more particularly between about 85 and about 95 wt % polyurethane polymer.

The isocyanate functions to form the polyurethane polymer through the reaction with polyols. In one embodiment, the polyurethane polymer includes between about 1 and about 45 wt % isocyanate, particularly between about 5 and about 30 wt % isocyanate, and more particularly between about 7 and about 20 wt % isocyanate.

The (meth)acrylate-containing alcohol functions to introduce crosslinking within the composition. Examples of suitable (meth)acrylate-containing alcohols include, but are not limited to: epoxy (meth)acrylate from 1,6-hexanediol, epoxy (meth)acrylate from (poly) propylene glycol, epoxy (meth)acrylate from (poly) ethylene glycol, epoxy (meth)acrylate from 1,4-butanediol, epoxy (meth)acrylate from bisphenol A, epoxy (meth)acrylate from phthalic acid, epoxy (meth)acrylate from hexahydro phthalic acid, epoxy (meth)methacrylate from resorcinol, and combinations thereof. In one embodiment, the (meth)acrylate-containing alcohol has at least one (meth)acrylate group and at least one alcohol group. In one embodiment, the polyurethane polymer includes between about 0.1 and about 20 wt % (meth)acrylate-containing alcohol, particularly between about 0.5 and about 10 wt % (meth)acrylate-containing alcohol, and more particularly between about 0.5 and about 5 wt % (meth)acrylate-containing alcohol.

The polyol component functions to form the polyurethane polymer through the reaction with isocyanates. In one embodiment, the polyol component has a urethane backbone. Examples of suitable polyol components include, but are not limited to: polyester polyols, polyether polyols, polycarbonate polyols, polybutadiene polyols, and combinations thereof. In one embodiment, the polyurethane polymer includes between about 50 and about 98 wt % polyol component, particularly between about 60 and about 95% polyol component, and more particularly between about 70 and about 90 wt % polyol component.

The polyol is selected to have certain solubility parameters computed employing group contribution methods as described in the paper by K. L. Hoy, J. Coated Fabrics. Volume 19, 53 (1989). The calculations are carried out employing the program Molecular Modeling Pro Plus from Norgwyn Montgomery Software, Inc. (North Wales, Pa.). In favored embodiments, the polyol has a total solubility parameter or at least 8.0, 8.5, 8.8, 9.0, or 10 (cal/cm³)^{1/2}. The total solubility parameter of the polyol is typically no greater than 11.0 (cal/cm³)^{1/2}. The hydrogen bonding solubility parameter of the polyol is typically at least 0.5, 1.0, 1.5, 2.0, 2.5, 3.0, 3.1, 3.2, 3.3, 3.4, or 3.5 (cal/cm³)^{1/2} and typically no greater than 5 (cal/cm³)^{1/2}. In some embodiments, the hydrogen bonding solubility parameter of the polyol is no greater than 4.0 (cal/cm³)^{1/2}. In some embodiments, the dispersion solubility parameter can range from about 7 to 9 (cal/cm³)^{1/2}. Further, the polar solubility parameter can range from about 1.5 to 5.5 (cal/cm³)^{1/2}.

The polyurethane polymer including the reaction product of isocyanate, a (meth)acrylate-containing alcohol having at least one (meth)acrylate group and at least one alcohol group, and a polyol component having a defined solubility parameter of less than about 10 is prepared by mixing polyols, chain extenders, (meth)acrylate containing alcohols, inhibitors, catalysts and solvents to form a solution. The solution is heated with stirring, and then the polyisocyanates are added. In one embodiment, the solution is heated to about 80° C. The temperature of the solution is maintained to obtain the methacrylate group containing polyurethane polymer. The reaction is complete when no isocyanate groups remain. In one embodiment, this can be determined by using Fourier-transform infrared spectroscopy (FT-IR).

After formation of the polyurethane polymer, an oligomer including a multifunctional (meth)acrylate and a photoinitiator are added and mixed to form a homogeneous coating solution.

The oligomer including a multifunctional (meth)acrylate functions to cross-link the polyurethane polymers. In one embodiment, the oligomer is a reactive oligomer. For example, the reactive oligomer may be a multifunctional reactive component such as, without limitation, acrylate or urethane acrylate. Examples of suitable oligomers include, but are not limited to: urethane oligomers such as CN983, CN965, CN966, CN9893, and CN996, available from Sartomer, Exton, PA and ETERCURE DR-U299, DR-U388, DR-U249, and DR-U282 available from Eternal Chemical, Kaohsiung, Taiwan. In addition to urethane oligomers, other types of reactive oligomers such as polyester acrylate oligomers such as CN2250 and CN2254 and epoxy acrylate oligomers such as CN120 and CN114 available from Sartomer, Exton, PA are also suitable. In one embodiment, the light radiation debondable pressure sensitive adhesive includes between about 2 and about 30 wt % oligomer, particularly between about 5 and about 20 wt % oligomer, and more particularly between about 5 and about 15 wt % oligomer.

A photoinitiator is used to cure the light radiation debondable pressure sensitive adhesive. Typically, the initiator or initiators are activated by exposure to light of the appropriate wavelength and intensity. In one embodiment, ultraviolet (UV) light is used. Exemplary suitable photoinitiators include, but are not limited to, benzoin ethers (e.g., benzoin methyl ether or benzoin isopropyl ether) or substituted benzoin ethers (e.g., anisoin methyl ether). Other exemplary suitable photoinitiators include, but are not limited to, substituted acetophenones such as 2,2-diethoxyacetophenone or 2,2-dimethoxy-2-phenylacetophenone (commercially available under the trade designation IRGACURE 651 from BASF Corp. (Florham Park, NJ, USA) or under the trade designation ESACURE KB-1 from Sartomer (Exton, PA, USA)). Still other exemplary suitable photoinitiators include, but are not limited to, substituted alpha-ketols such as 2-methyl-2-hydroxypropiophenone, aromatic sulfonyl chlorides such as 2-naphthalenesulfonyl chloride, and photoactive oximes such as 1-phenyl-1,2-propanedione-2-(O-ethoxycarbonyl)oxime. Other suitable photoinitiators include, for example, 1-hydroxycyclohexyl phenyl ketone (commercially available under the trade designation IRGACURE 184), bis(2,4,6-trimethylbenzoyl)phenylphosphineoxide (commercially available under the trade designation IRGACURE 819), 2,4,6-trimethylbenzoylphenylphosphinic acid ethyl ester (commercially available under the trade designation IRGACURE TPO-L), 1-[4-(2-hydroxyethoxy)phenyl]-2-hydroxy-2-methyl-1-propane-1-one (commercially available under the trade designation IRGACURE 2959), 2-benzyl-2-dimethylamino-1-(4-morpholinophenyl)butanone (commercially available under the trade designation IRGACURE 369), 2-methyl-1-[4-(methylthio)phenyl]-2-morpholinopropan-1-one (commercially available under the trade designation IRGACURE 907), and 2-hydroxy-2-methyl-1-phenyl propan-1-one (commercially available under the trade designation DAROCUR 1173 from Ciba Specialty Chemicals Corp. (Tarrytown, NY, USA). While the specification primarily describes use of a photoinitiator, other methods may be used without departing from the intended scope of the present invention. For example, a thermal initiator may be used to replace the photo-imitator in the formulations, which would lead to thermally induced cross-linking process to form the de-bondable adhesives. In one embodiment, the light radiation debondable pressure sensitive adhesive includes between about 0.1 and about 2 wt % photoinitiator, particularly between about 0.1 and about 1 wt % photoinitiator, and more particularly between about 0.3 and about 0.6 wt % photoinitiator.

Other materials can be added to the light radiation debondable pressure sensitive adhesive for special purposes, including, for example: stabilizers, adhesion promoters, ultraviolet light absorbers, crosslinking agents, surface modifying agents, ultraviolet light stabilizers, antioxidants, antistatic agents, thickeners, fillers, pigments, colorants, dyes, thixotropic agents, processing aids, nanoparticles, fibers and combinations thereof.

In one embodiment, the light radiation debondable pressure sensitive adhesive has thickness in the range of between about 0.5 and about 4 mil, particularly between about 1 mil and about 2 mil.

Upon UV-radiation, the tan delta of the light radiation debondable pressure sensitive adhesive decreases. In one embodiment, the tan delta before U V radiation is at least about 0.9 and particularly at least about 1.0 at 70° C. In one embodiment, the tan delta after UV-radiation is less than about 0.8 and particularly less than about 0.6. The tan delta is defined as the ratio of G″ (loss modulus)/G′ (storage modulus).

In one embodiment, the light radiation debondable pressure sensitive adhesive of the present invention is optically clear. As used herein, the term “optically clear” refers to a material that has a haze of less than about 5%, particularly less than about 2% and more particularly less than about 1%; a luminous transmission of greater than about 88%, particularly greater than about 89%, and more particularly greater than about 90%; and an optical clarity of greater than about 98%, particularly greater than about 99%, and more particularly greater than about 99.5% when cured. Typically, the clarity, haze, and transmission are measured on a construction in which the adhesive is held between two optical films, such as poly(ethylene terephthalate) (PET). The measurement is then taken on the entire construction, including the adhesive and the substrates. Both the haze and the luminous transmission can be determined using, for example, ASTM-D 1003-92. The optical measurements of transmission, haze, and optical clarity can be made using, for example, a BYK Gardner haze-gard plus 4725 instrument (Geretsried, Germany). The BYK instrument uses an illuminant “C” source and measures all the light over that spectral range to calculate a transmission value. Haze is the percentage of transmitted light that deviates from the incident beam by more than 2.5°. Optical clarity is evaluated at angles of less than 2.5°. Typically, the light radiation debondable pressure sensitive adhesive is visually free of bubbles.

In practice, the light radiation debondable pressure sensitive adhesive of the present invention can be used to form a laminate. In one embodiment, the laminate includes a substrate having a first major surface and glass having a first major surface. In one embodiment, the substrate is a polymer substrate. The light radiation debondable pressure sensitive adhesive is positioned between the substrate and the glass. The laminate including the light radiation debondable pressure sensitive adhesive can be used in a display assembly. The display assembly can further include one or more substrates (e.g., permanently or temporarily attached to the light radiation debondable pressure sensitive adhesive), another adhesive layer, or a combination thereof. As used herein, the term “adjacent” can be used to refer to two layers that are in direct contact or that are separated by one or more thin layers, such as primer or hard coating. Often, adjacent layers are in direct contact. Additionally, laminates are provided wherein the light radiation debondable pressure sensitive adhesive is positioned adjacent an optical film. Optical films intentionally enhance, manipulate, control, maintain, transmit, reflect, refract, absorb, retard, or otherwise alter light that impinges upon a surface of the film. Films included in the laminates include classes of material that have optical functions, such as polarizers, interference polarizers, reflective polarizers, diffusers, colored optical films, mirrors, louvered optical film, light control films, transparent sheets, brightness enhancement film, anti-glare, and anti-reflective films, and the like. Films for the provided laminates can also include retarder plates such as quarter-wave and half-wave phase retardation optical elements. Other optically clear films include anti-splinter films and electromagnetic interference filters.

In some embodiments, the resulting laminates can be optical elements or can be used to prepare optical elements. As used herein, the term “optical element” refers to an article that has an optical effect or optical application. The optical elements can be used, for example, in electronic displays, architectural applications, transportation applications, projection applications, photonics applications, and graphics applications. Suitable optical elements include, but are not limited to, glazing (e.g., windows and windshields), screens or displays, cathode ray tubes, and reflectors.

Exemplary optically clear substrates include, but are not limited to: a display panel, such as liquid crystal display, an OLED display, a touch panel, electrowetting display or a cathode ray tube, a window or glazing, an optical component such as a reflector, polarizer, diffraction grating, mirror, or cover lens, another film such as a decorative film or another optical film.

Representative examples of optically clear substrates include glass and polymeric substrates including those that contain polycarbonates, polyesters (e.g., polyethylene terephthalates and polyethylene naphthalates), polyurethanes, poly(meth)acrylates (e.g., polymethyl methacrylates), polyvinyl alcohols, polyolefins such as polyethylenes, polypropylenes, and cellulose triacetates. Typically, cover lenses can be made of glass, polymethyl methacrylates, or polycarbonate.

Before being exposed to light radiation, the light radiation debondable pressure sensitive adhesive has a strong bond to both the substrate and the glass. In use, for example, when the laminate is part of an OLED stack, after the OLED stack is fabricated, light radiation is applied on the light radiation debondable pressure sensitive adhesive. The desired effect is a differential adhesion between the glass and substrate interfaces. The adhesion of the light radiation debondable pressure sensitive adhesive to the substrate remains strong even after sufficient irradiation exposure is applied to debond from the glass. In one embodiment, the adhesion to glass is reduced to less than about 300 g/in, particularly less than about 200 g/in, and more particularly less than about 50 g/in. This reduced adhesion to glass after exposure to light radiation allows the light radiation debondable pressure sensitive adhesive and substrate to be easily and cleanly peeled from the glass. The adhesion of the light radiation debondable pressure sensitive adhesive to a substrate can be measured by peel adhesion. In one embodiment, the peel adhesion of the light radiation debondable pressure sensitive adhesive to glass decreases by at least about 20%, particularly by at least about 50%, and more particularly by at least about 70% after being exposed to light radiation.

In one embodiment, when the light radiation debondable pressure sensitive adhesive is laminated to glass, the pressure sensitive adhesive has a peel adhesion of about 3 Newtons per centimeter or more, and particularly of about 5 Newtons per centimeter or more, prior to being exposed to light radiation. In one embodiment, when the light radiation debondable pressure sensitive adhesive is laminated to glass and exposed to light radiation, the light radiation debondable pressure sensitive adhesive has a peel adhesion of about 2 Newtons per centimeter or less, particularly about 1.5 Newtons per centimeter or less, and more particularly about 1 Newton per centimeter or less.

The light radiation debondable pressure sensitive adhesive of the present invention enables OLED manufactures to develop more flexible/foldable devices. Typically, flexible/foldable devices are fabricated with the assistance of rigid substrates. The light radiation debondable pressure sensitive adhesive allows for a simpler manufacturing process. For example, in some applications, ultra-thin flexible glass can be used as the cover-glass. The light radiation debondable pressure sensitive adhesive of the present invention allows flexible glass to be part of multilayer constructions from which the OLED can be fabricated directly on the flexible glass substrates. After release the light radiation debondable pressure sensitive adhesive cleanly from the glass, the out-surface of the glass can be used as the cover glass.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis.

Materials

| Designation | Description, Source |
|---|---|
| MEK | Methyl ethyl ketone, solvent |
| | obtained from Avantor Performance |
| | Materials, Inc., Center Valley, PA |
| DBTDA | Dibutyltin diacetate catalyst obtained |
| | from Sigma-Aldrich Chemical Co., |
| | St. Louis, MO |
| YMER N120 | PEG-modified diol obtained under |
| | trade designation “YMER N120” |
| | from Perstorp, Malmo, Sweeden |
| PRIPLAST 1838 | C36 dimer-based polyester polyol, |
| | amorphous, Mn of 2000, obtained |
| | under trade designation “PRIPLAST |
| | 1838” from Croda Inc, Edison, NJ |
| DESMODUR W | Monomeric cycloaliphatic diisocyanate, |
| | obtained under the trade name |
| | “DESMODUR W” from Covestro, |
| | Pittsburgh, PA |
| BAGDM | Bisphenol A glycerolate dimethacrylate, |
| | obtained from Sigma-Aldrich |
| | Chemical Co., St. Louis, MO |
| IRGACURE 819 | Phosphine oxide, phenyl bis (2,4,6-trimethyl |
| | benzoyl), obtained under |
| | trade designation “IRGACURE 184” |
| | from BASF America, Florham |
| | Park, NJ |
| ETERCUR DR- | A bi-functional polyurethane oligomer, |
| U384 | obtained from Eternal Chemical, |
| | Kaohsiung City, Taiwan |
| CN983 | an aliphatic polyester based urethane |
| | diacrylate oligomer, obtained from |
| | Sartomer, Exton, PA |
| CN996 | a difunctional aromatic urethane |
| | acrylate oligomer, obtained from |
| | Sartomer, Exton, PA. |
| CN2250 | A tetra-functional polyester acrylate |
| | oligomer, obtained from Sartomer, |
| | Exton, PA |
| CN2254 | A bi-functional polyester acrylate |
| | oligomer, obtained from Sartomer, |
| | Exton, PA |
| RF02N | Silicone coated polyester release liner, |
| | obtained from SKC Haas Display |
| | Films Co. Ltd., Cheonan, South Korea |
| RF32N | Silicone coated polyester release liner, |
| | obtained from SKC Haas Display |
| | Films Co. Ltd., Cheonan, South Korea |

### Test Method 1. Dynamic Mechanical Analysis (DMA)

Dynamic mechanical analysis (DMA) was accomplished using an DHR3 PARALLEL PLATE RHEOMETER (TA Instruments) to characterize the physical properties of each sample as a function of temperature. For each sample, approximately 0.5 g of material was centered between 8 mm diameter parallel plates of the rheometer and compressed until the edges of the sample were uniform with the edges of the top and bottom plates. The furnace doors that surround the parallel plates and shafts of the rheometer were shut and the temperature was raised to 140° C. and held for 5 minutes. The temperature was then ramped from 120° C. to −20° C. at 3° C./min while the parallel plates were oscillated at a frequency of 1 Hz and a constant % strain of 0.4%. While many physical parameters of the material were recorded during the temperature ramp, storage modulus (G′), loss modulus (G″), and tan delta are of primary importance in the characterization of the homopolymers of this disclosure.

The glass transition temperature (Tg) of the adhesive composition can be measured by first determining its storage (G′) and loss shear moduli (G″). The ratio of G″/G′, a unit less parameter typically denoted “tan delta”, was plotted versus temperature. The maximum point (point where the slope was zero) in the transition region between the glassy region and the rubbery region of the tan delta curve (if well defined) determined the Tg of the adhesive composition at that particular frequency.

### Testing Method 2: Optical Measurement

The haze (%) and transmission (%) were measured using a Haze-Gard Plus from BYK-Gardner USA, Columbia, Md. Prior to testing, the easy liner of the PSA sample was removed, the PSA samples were then laminated to a glass slide, and the tight liner was also removed when the optical measurement was performed. Three measurements per sample was recorded and the average data were reported.

### Testing Method 3: Peel Adhesion

For 180 degree peel adhesion tests to glass, each sample was laminated between 2 mil PET and glass and the samples were then aged at room temperature for 24 hours. Peel adhesion was measured according to the standard test method described in ASTM D3330-90.

### Preparation of Polyurethane Polymer I

To a resin reaction vessel equipped with a mechanical stirrer, a condenser, a thermocouple, and a nitrogen inlet, 201.59 g Priplast 1838 (eqv. weight=984). Ymer 120 of 6.0 g, bisphenol A-glycidyl methacrylate of 1.2 g, 0.073 g butylated hydroxytoluene (BHT), and 200 g MEK were added. The solution was heated up to 80° C. with stirring, then 0.12 g dibutyltin diacetate (DBTDA) and 29.35 g of Desmodur M was added. The temperature was maintained at 80±2° C. to obtain the methacrylate group containing polyurethane polymer. During the reaction, the desired amount of MEK was added into the system to dilute the viscosity. The reaction was completed when no isocyanate groups existed, which was monitored by using FT-IR for the disappearance of the NCO peak at around 2274 cm-1. Finally, the clear viscous solution with a solid content of 40% by weight was obtained. The inherent viscosity (IV) was measured as 0.56 deciliters per gram.

### Preparation of Polyurethane Polymer II

To a resin reaction vessel equipped with a mechanical stirrer, a condenser, and a nitrogen inlet, 200 gram (g) of Priplast 1838, 80 g of MEK, Bis-GA of 0.59 g (phenol A-glycerolate acrylate), DBTDA of 0.11 g and BTH of 0.068 g were added. The solution was heated up to 75° C. and 26.14 g of DES-W was added while stirring. The temperature was maintained at 75±2° C. until the NCO peak at around 2270 cm⁻¹ disappeared as observed by FT-IR. During the reaction, an additional 200 g MEK was added to adjust the solids content to around 40 wt %, resulting in clear and transparent polyurethane solution.

### Preparation of UV De-Bondable OCA Formulations

### Example 1

In a brown jar, 50 g of polyurethane polymer I (40% wt solid in MEK), 4 g of CN983 (50% wt in MEK), and 0.88 g of Irgacure 819 (10% wt solid in MEK) were mixed together and the solution was rolled for 2 hours to form a homogenous coating solution.

### Example 2

In a brown jar, 50 g of Polyurethane Polymer I (40% wt solid in MEK), 4 g of CN996 (50% wt in MEK), and 0.88 g of Irgacure 819 (10% wt solid in MEK) were mixed together and the solution was rolled for 2 hours to form a homogenous coating solution.

### Example 3

In a brown jar, 50 g of polyurethane polymer I (40% wt solid in MEK), 4 g of ETERCUR DR-U384 (50% wt in MEK), and 0.88 g of Irgacure 819 (10% wt solid in MEK) were mixed together and the solution was rolled for 2 hours to form a homogenous coating solution.

### Example 4

In a brown jar, 50 g of polyurethane polymer I (40% wt solid in MEK), 4 g of CN2250 (50% wt in MEK), 0.88 g of Irgacure 819 (10% wt solid in MEK) were mixed together and the solution was rolled for 2 hours to form a homogenous coating solution.

### Example 5

In a brown jar, 50 g of Polyurethane polymer II (40% wt solid in MEK), 4.0 g of CN983 (50% wt in MEK), 0.88 g of Irgacure 819 (10% wt solid in MEK) were mixed and the solution was rolled for 2 hours to form a homogenous coating solution.

### Example 6

In a brown jar, 50 g of polyurethane polymer II (40% wt solid in MEK), 4 g of CN2250 (50% wt in MEK), and 0.88 g of Irgacure 819 (10% wt solid in MEK) were mixed together and the solution was rolled for 2 hours to form a homogenous coating solution.

### Comparable Example 1

In a brown jar, 50 g of polyurethane polymer I (40% wt solid in MEK), 4 g of CN2254 (50% wt in MEK), and 0.88 g of Irgacure 819 (10% wt solid in MEK) were mixed together and the solution was rolled for 2 hours to form a homogenous coating solution.

### Preparation of UV-Debondable OCA Samples

The coating solutions Examples 1-6 and Comparable Example 1 were coated on 3 mil thick RF32N (tight liner, polyester release liners from SKC) using a knife coater, the gap between the knife and RF32N were set to be about 0.1 mm. The coated samples were dried at room temp for 5 minutes and were then transferred to a 70° C. oven for 20 minutes. An easy liner of RF02N (2 mil, polyester release liners from SKC) was then laminated on the PSA top surfaces, which resulted in UV-debondable, optically clear pressure sensitive adhesives protected by a laminated easy liner, RF02N, and coating tight liner, RF32N. All of the samples were stored in black bags and kept away from light.

### Adhesive Properties

### Peel Adhesion Tests:

The easy liner, RF02N, of the UV-bondable OCA samples was first peeled off, then a 2-mil PET film was laminated on the OCA surface. After that, the OCA was cut to 1-inch strips, the tight RF32N liner was peeled off, the OCA strips were laminated on glass. Half of the OCA samples were post-cured using a Fusion System Model 1600 configured with a D-bulb (available from Fusion UV Systems, Gaithersburg MD). All the samples were further aged at controlled humidity (60%) and temperature (75° C.) for 24 hours before peeling. All the samples were peeled at 12 inch/min using Imass peel tester. The haze, amount of UV cure, peel adhesion, and failure mode are shown below in Table 1.

TABLE 1
180-degree peel adhesion on glass

| | | | Peel adhesion | Failure |
|---|---|---|---|---|
| | Haze | UV-Cure | (g/inch) | Mode |
| Example 1 | 0.68 | 0 | 1347 | Adhesive |
| | | 3J | 128.6 | Adhesive |
| Example 2 | 0.79 | 0 | 1036 | Cohesive |
| | | 3J | 5.6 | Adhesive |

As can be seen in Table 1, the peel adhesion before and after UV-cure showed a significant difference. The peel adhesion before UV cure is high, mostly due to cohesive failure. The intended use of the light radiation debondable pressure sensitive adhesive of the present invention is to provide good bonding strength on glass during the device (such OLED) fabrication process. Most importantly, the peel adhesion after UV cure was significantly reduced, for example, the PU350-CN996 formulation was reduced to a few grams/inches. As can be seen from the results, the light radiation debondable pressure sensitive adhesive can be easily and cleanly removed from glass surfaces without adding any peel stress to the rest of device.

The DMA data of both Examples 1 and 2 were tested and are shown below in Table 2.

TABLE 2
Rheology Properties of UV-Debondable OCA Samples

| | G′ | G′ | G′ | Tan | Tan | Tan | |
|---|---|---|---|---|---|---|---|
| | at 25 C. | at 60 C. | at 70 C. | Delta | Delta at | Delta at | Tg |
| | (mPa) | (mPa) | (mPa) | at 25 C. | 60 C. | 70 C. | (° C.) |
| PU350 CN983 -0J | 1.87E−01 | 2.84E−02 | 1.73E−02 | 0.68 | 1.21 | 1.38 | −34.6 |
| PU350 CN983 -3J | 3.78E−01 | 1.13E−01 | 8.87E−02 | 0.51 | 0.58 | 0.55 | −32.78 |
| PU350 CN996 -0J | 1.58E−01 | 2.59E−02 | 1.61E−02 | 0.72 | 1.27 | 1.44 | −34.5 |
| PU350 CN996-3J | 2.03E−01 | 4.95E−02 | 3.60E−02 | 0.59 | 0.75 | 0.77 | −33.8 |

The optical and peel adhesion data of other examples are listed in Table 3. As shown in Table 1, the reactive oligomer cross-linkers have a significant impact on the final adhesive properties, both optically and mechanically. With CN983 and CN996 as cross-linkers, the UV-debondable OCA samples of Example 1 and 2 are optically clear with a haze of less than 1%. The adhesives showed very good UV-debonding properties by significantly reducing its adhesion on glass after UV cure. Other types of oligomer cross-linkers showed some degree of incompatibility with the polyurethane adhesive polymer, resulting in increased optical haze. For Examples 3-6, upon UV curing, the UV-debondable OCA samples also showed reduced peel adhesion on glass, at least 30%. Interestingly, the di-functional polyester acrylate, CN2254, did not reduce its adhesion on glass at all.

TABLE 3
Optical and Peel Adhesion Data

| | % | | | Peel adhesion | Peel Adhesion |
|---|---|---|---|---|---|
| | Trans- | % | % | N/cm | N/cm |
| | mission | Haze | Clarity | (before UV) | After UV |
| Example 1 | 93.4 | 0.7 | 98 | 6.24 | 0.47 |
| | | | | (Adhesive) | (Adhesive) |
| Example 3 | 90 | 9.4 | 94.7 | Not Tested | Not Tested |
| Example 4 | 92.5 | 25.7 | 95.6 | 3.29 (2-bond) | 1.35 |
| | | | | | (adhesive) |
| Example 5 | 93.2 | 6.8 | 96 | 8.47 (2-bond) | 1.34 |
| | | | | | (Adhesive) |
| Example 6 | 93.2 | 68.5 | 93 | 8.41 (2-bond) | 1.79 |
| | | | | | (adhesive) |
| Com- | 92.4 | 20.7 | 96 | 3.3 (2-bond) | 5.83 (2-bond) |
| parable | | | | | |
| Example 1 | | | | | |

Although the present invention has been described with reference to preferred embodiments, workers skilled in the art will recognize that changes may be made in form and detail without departing from the spirit and scope of the invention.

What is claimed is:

1. A pressure sensitive adhesive comprising:
a polyurethane polymer comprising a reaction product of:
an isocyanate;
a (meth) acrylate-containing alcohol having at least one (meth)acrylate group and at least one alcohol group; and
a polyol component having a defined solubility parameter of less than about 10;
an oligomer comprising a multifunctional (meth)acrylate; and
a photoinitiator,
wherein a peel adhesion of the pressure sensitive adhesive to glass decreases by at least about 20% after being exposed to light radiation.

2. The pressure sensitive adhesive of claim 1, wherein when the pressure sensitive adhesive is laminated to glass, the pressure sensitive adhesive has a peel adhesion to the glass of about 3 Newtons per centimeter or more prior to being exposed to light radiation.

3. The pressure sensitive adhesive of claim 1, wherein when the pressure sensitive adhesive is laminated to glass, the pressure sensitive adhesive has a peel adhesion to the glass of about 5 Newtons per centimeter or more prior to being exposed to light radiation.

4. The pressure sensitive adhesive of claim 1, wherein when the pressure sensitive adhesive is laminated to glass and exposed to light radiation, the pressure sensitive adhesive has a peel adhesion to the glass of about 2 Newtons per centimeter or less.

5. The pressure sensitive adhesive of claim 1, wherein when the pressure sensitive adhesive is laminated to glass and exposed to light radiation, the pressure sensitive adhesive has a peel adhesion to the glass of about 1.5 Newtons per centimeter or less.

6. The pressure sensitive adhesive of claim 1, wherein when the pressure sensitive adhesive is laminated to glass and exposed to light radiation, the pressure sensitive adhesive has a peel adhesion to the glass of about 1 Newton per centimeter or less.

7. The pressure sensitive adhesive of claim 1, wherein the pressure sensitive adhesive has a haze value of less than about 5%.

8. The pressure sensitive adhesive of claim 1, wherein the pressure sensitive adhesive has a haze value of less than about 2%.

9. The pressure sensitive adhesive of claim 1, wherein the oligomer comprising a multifunctional (meth)acrylate is a reactive oligomer.

10. The pressure sensitive adhesive of claim 1, wherein the light radiation is UV curing.

11. A composition comprising:
a polyurethane polymer comprising a reaction product of:
an isocyanate;
a (meth)acrylate-containing alcohol having at least one (meth)acrylate group and at least one alcohol group; and
a polyol component having a defined solubility parameter of less than about 10;
a reactive oligomer comprising a multifunctional (meth)acrylate; and
a photoinitiator,
wherein when the composition is laminated to glass and UV radiated, the composition has a peel adhesion to the glass of about 2 Newtons per centimeter or less.

12. The composition of claim 11, wherein the composition is optically clear.

13. The composition of claim 11, wherein the composition has a haze value of less than about 5%.

14. The composition of claim 11, wherein when the composition is laminated to glass and UV cured, the composition has a peel adhesion to the glass of about 1.5 Newtons per centimeter or less.

15. The composition of claim 11, wherein when the composition is laminated to glass and UV cured, the composition has a peel adhesion to the glass of about 1 Newton per centimeter or less.

16. The composition of claim 11, wherein the polyol component has a urethane backbone.

17. A laminate comprising:
a substrate having at least one major surface;
glass substrate having at least one major surface; and
a pressure sensitive adhesive comprising:
a polyurethane polymer which is a reaction product of:
an isocyanate;
a (meth) acrylate-containing alcohol having at least one (meth)acrylate group and at least one alcohol group; and
a polyol component having a defined solubility parameter of less than about 10;
a reactive oligomer comprising a multifunctional (meth) acrylate; and
a photoinitiator,
wherein after exposure to light radiation, the pressure sensitive adhesive has a peel adhesion to the glass of about 2 Newtons per centimeter or less.

18. The laminate of claim 17, wherein the pressure sensitive adhesive is optically clear.

19. The laminate of claim 17, wherein a peel adhesion of the pressure sensitive adhesive to the glass decreases by at least about 20% after being exposed to light radiation.
